(19) United States
(12) Patent Application Publication
(10) Pub. No.: US 2019/0102377 A1
(43) Pub. Date: Apr. 4, 2019

(54) Robot Natural Language Term Disambiguation and Entity Labeling

(71) Applicant: Anki, Inc., San Francisco, CA (US)

(72) Inventors: Brad Neuman, San Francisco, CA (US); Andrew Neil Stein, San Francisco, CA (US); Lee Crippen, Berkeley, CA (US)

(21) Appl. No.: 15/725,209

(22) Filed: Oct. 4, 2017

(51) Int. Cl. G06F 17/27; G06K 9/00; G06K 9/66; G06F 3/01; G10L 15/22; G10L 15/18; B25J 9/00; B25J 9/16

(52) U.S. Cl. CPC G06F 17/2785; B25J 9/1628; G06K 9/66; G06K 9/00355; G06F 3/013; G06F 3/017; G10L 15/22; G10L 15/1815; B25J 9/0003; B25J 9/1694; B25J 9/1697; Y10S 901/01; Y10S 901/30; Y10S 901/47; G10L 2015/223; G06K 9/00664

(57) ABSTRACT

A apparatus, e.g., a robot, that uses sensor inputs and physical actions to disambiguate terms in natural language commands and corresponding methods, systems, and computer programs encoded on computer storage media. A robot can receive a natural language command from a user having an ambiguous term that references a location or an entity in an environment of the robot. A user location indicator is identified from one or more sensor inputs. A location within the environment of the robot is computed using the location indicator identified from the one or more sensor inputs. Resolution data is computed using the computed location, wherein the resolution data resolves the reference of the ambiguous term. One or more actions are generated using the natural language command and the resolved reference of the ambiguous term, and the robot can execute the one or more actions.

### BACKGROUND

This specification relates to robots, and more particularly to robots used for consumer purposes.

A robot is a physical machine that is configured to perform physical actions autonomously or semi-autonomously. Robots have one or more integrated control subsystems that effectuate the physical movement of one or more robotic components in response to particular inputs. Robots can also have one or more integrated sensors that allow the robot to detect particular characteristics of the robot's environment. In this specification, a robot refers to any appropriate physical machine having such characteristics. Thus, the term “robot” encompasses physical machines capable of physically moving on a surface; through the air, e.g., unmanned aerial vehicles or “drones”; on or under water; or some combination of these.

Modern day robots are typically electronically controlled by dedicated electronic circuitry, programmable special-purpose or general-purpose processors, or some combination of these. Robots can also have integrated networking hardware that allows the robot to communicate over one or more communications networks, e.g., over Bluetooth, NFC, or WiFi.

Robots can use natural language understanding (NLU) techniques to receive natural language input, e.g., through text-based or voice commands. Natural language understanding is a field of computational linguistics that aims to derive the meaning of natural language inputs. One problem posed by natural language understanding is term disambiguation, which refers broadly to the problems involved with determining the meaning of a term having multiple possible meanings. Such terms can be terms that refer backwards to other terms in previously stated expressions, which is commonly referred to as anaphora, as well as terms that refer forwards to other terms in subsequently stated expressions, which is commonly referred to as cataphora.

### SUMMARY

This specification describes how a robot can use integrated sensor inputs and possibly one or more physical actions to disambiguate terms in natural language commands issued by a user. This capability makes user interaction with the robot more natural and in turn makes the robot seem more life-like.

When users are interacting with robots, they often provide, by natural language commands, terms that are references to things in the robot's environment, e.g., “Go there,” “Play with him”, or “Pick that up.” Without any context, the terms “there,” “that,” and “him” in these example commands are non-specific, ambiguous terms because the meaning of these terms cannot be determined from the command itself. Some commands even have multiple ambiguities that a person would readily understand from other cues, e.g., “This is my room,” while gesturing towards and looking around a room.

Robots have a number of advantages over other computer-controlled systems for disambiguating natural language terms because robots can thoroughly and autonomously examine their operating environment. In particular, a robot can perform physical actions to observe a location indicator provided by a user. A robot can then use the determined location indicator to identify something in the robot's environment to which the term refers in order to disambiguate the term. In this context, the location can be either a point in space, a distribution of points in space, or a region, to name just a few examples.

In this specification, an ambiguous term, or equivalently, a non-specific term, is a term in a command that references something in a robot's environment and that cannot be resolved from text of the command itself. Resolving an ambiguous term means determining a location or another entity to which the term refers. For example, the robot can resolve the term “there” by determining that “there” refers to a particular location in the environment to which the user is pointing or looking. As another example, the robot can resolve the term “that” by determining that “that” refers to a particular object in the environment and then recognizing a name for the object. After resolving the references, a robot can then assign names to physical entities so that previously ambiguous terms can be used in subsequent commands. For example, after determining that “my room” refers to a particular location in a user's home, the robot can label the location with the name “my room” and thereafter understand a subsequent command that uses the name, e.g., “go to my room.” In addition, the robot can use the possessive pronoun “my” to associate a physical entity or location with a particular user of the robot speaking the command. For example, if the speaker's name was Lee, therefore, the robot can also disambiguate commands that reference “Lee's room” or “Lee's toy” as references to the physical location or entity.

Particular embodiments of the subject matter described in this specification can be implemented so as to realize one or more of the following advantages. Disambiguating terms in natural language can make a robot easier to use because it allows a user to specify commands more naturally rather than having to memorize a rigid set of commands. This therefore increases user engagement, makes the robot's actions easier to understand, and makes the entire interaction more natural and life-like. A technique that helps the robot to more effectively understand the user and what he or she is asking for, helps the robot to evolve in the mind of the user, from mere robot/instrumental item, to friend or partner to the user.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example robot.

FIG. 2 illustrates the architecture of an example term resolution subsystem of a robot.

FIG. 3 is a flowchart of an example process for a robot to generate a modified command that resolves an ambiguous term in a command.

FIG. 4 is a flowchart of an example process for a robot to resolve an ambiguous term in a command.

Like reference numbers and designations in the various drawings indicate like elements.

### DETAILED DESCRIPTION

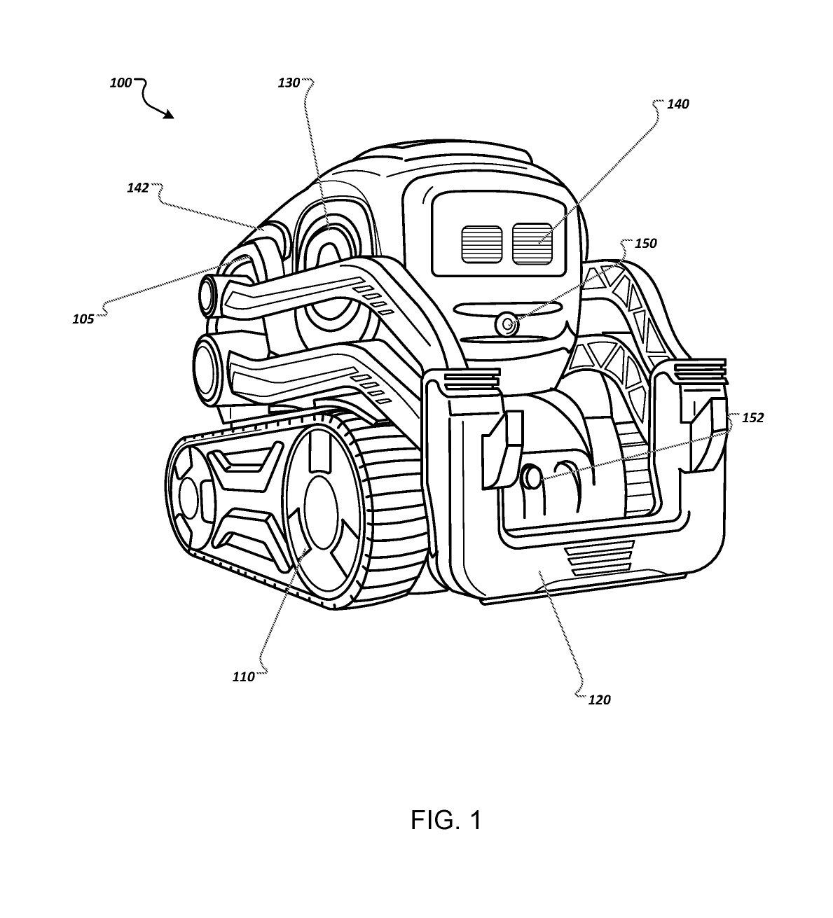

FIG. 1 illustrates an example robot 100. The robot 100 is an example of a mobile autonomous robotic system with which the term disambiguation techniques described in this specification can be implemented. The robot 100 can use the techniques described below for use as a toy or as a personal companion.

The robot 100 generally includes a body 105 and a number of physically moveable components. The components of the robot 100 can house data processing hardware and control hardware of the robot. The physically moveable components of the robot 100 include a locomotion system 110, a lift 120, and a head 130.

The robot 100 also includes integrated output and input subsystems.

The output subsystems can include control subsystems that cause physical movements of robotic components; presentation subsystems that present visual or audio information, e.g., screen displays, lights, and speakers; and communication subsystems that communicate information across one or more communications networks, to name just a few examples.

The control subsystems of the robot 100 include a locomotion subsystem 110. In this example, the locomotion system 110 has wheels and treads. Each wheel subsystem can be independently operated, which allows the robot to spin and perform smooth arcing maneuvers. In some implementations, the locomotion subsystem includes sensors that provide feedback representing how quickly one or more of the wheels are turning. The robot can use this information to control its position and speed.

The control subsystems of the robot 100 include an effector subsystem 120 that is operable to manipulate objects in the robot's environment. In this example, the effector subsystem 120 includes a lift and one or more motors for controlling the lift. The effector subsystem 120 can be used to lift and manipulate objects in the robot's environment. The effector subsystem 120 can also be used as an input subsystem, which is described in more detail below.

The control subsystems of the robot 100 also include a robot head 130, which has the ability to tilt up and down and optionally side to side. On the robot 100, the tilt of the head 130 also directly affects the angle of a camera 150.

The presentation subsystems of the robot 100 include one or more electronic displays, e.g., electronic display 140, which can each be a color or a monochrome display. The electronic display 140 can be used to display any appropriate information. In FIG. 1, the electronic display 140 is presenting a simulated pair of eyes. The presentation subsystems of the robot 100 also include one or more lights 142, e.g., LEDs, that the robot 100 can turn on and off, make dimmer or brighter, and optionally light up in multiple different colors.

The presentation subsystems of the robot 100 can also include one or more speakers, which can play one or more sounds in sequence or concurrently so that the sounds are at least partially overlapping.

The input subsystems of the robot 100 include one or more perception subsystems, one or more audio subsystems, one or more touch detection subsystems, one or more motion detection subsystems, one or more effector input subsystems, and one or more accessory input subsystems, to name just a few examples.

The perception subsystems of the robot 100 are configured to sense light from an environment of the robot. The perception subsystems can include a visible spectrum camera, an infrared camera, or a distance sensor, to name just a few examples. For example, the robot 100 includes an integrated camera 150. The perception subsystems of the robot 100 can include one or more distance sensors. Each distance sensor generates an estimated distance to the nearest object in front of the sensor.

The perception subsystems of the robot 100 can include one or more light sensors. The light sensors are simpler electronically than cameras and generate a signal when a sufficient amount of light is detected. In some implementations, light sensors can be combined with light sources to implement integrated cliff detectors on the bottom of the robot. When light generated by a light source is no longer reflected back into the light sensor, the robot 100 can interpret this state as being over the edge of a table or another surface.

The audio subsystems of the robot 100 are configured to capture from the environment of the robot. For example, the robot 100 can include a directional microphone subsystem having one or more microphones. The directional microphone subsystem also includes post-processing functionality that generates a direction, a direction probability distribution, location, or location probability distribution in a particular coordinate system in response to receiving a sound. Each generated direction represents a most likely direction from which the sound originated. The directional microphone subsystem can use various conventional beam-forming algorithms to generate the directions.

The touch detection subsystems of the robot 100 are configured to determine when the robot is being touched or touched in particular ways. The touch detection subsystems can include touch sensors, and each touch sensor can indicate when the robot is being touched by a user, e.g., by measuring changes in capacitance. The robot can include touch sensors on dedicated portions of the robot's body, e.g., on the top, on the bottom, or both. Multiple touch sensors can also be configured to detect different touch gestures or modes, e.g., a stroke, tap, rotation, or grasp.

The motion detection subsystems of the robot 100 are configured to measure movement of the robot. The motion detection subsystems can include motion sensors and each motion sensor can indicate that the robot is moving in a particular way. For example, a gyroscope sensor can indicate an orientation of the robot relative to the Earth's gravitational field. As another example, an accelerometer can indicate a direction and a magnitude of an acceleration.

The effector input subsystems of the robot 100 are configured to determine when a user is physically manipulating components of the robot 100. For example, a user can physically manipulate the lift of the effector subsystem 120, which can result in an effector input subsystem generating an input signal for the robot 100. As another example, the effector subsystem 120 can detect whether or not the lift is currently supporting the weight of any objects. The result of such a determination can also result in an input signal for the robot 100.

The robot 100 can also use inputs received from one or more integrated input subsystems. The integrated input subsystems can indicate discrete user actions with the robot 100. For example, the integrated input subsystems can indicate when the robot is being charged, when the robot has been docked in a docking station, and when a user has pushed buttons on the robot, to name just a few examples.

The robot 100 can also use inputs received from one or more accessory subsystems that are configured to communicate with the robot 100 and which can provide additional input and output devices. For example, the robot 100 can interact with one or more cubes that are configured with electronics that allow the cubes to communicate with the robot 100 wirelessly. Such accessories that are configured to communicate with the robot can have embedded sensors whose outputs can be communicated to the robot 100 either directly or over a network connection. For example, a cube can be configured with a motion sensor and can communicate an indication that a user is shaking the cube as an indication that the user is trying to interact with the robot. A cube can also be configured with lights or speakers that the robot can control wirelessly.

The robot 100 can also use inputs received from one or more environmental sensors that each indicate a particular property of the environment of the robot. In addition to cameras and microphones, example environmental sensors include temperature sensors, ambient IR or light sensors, and humidity sensors to name just a few examples.

One or more of the input subsystems described above may also be referred to as “sensor subsystems.” The sensor subsystems can allow a robot to determine when a user is paying attention to the robot, e.g., for the purposes of providing user input, using a representation of the environment rather than through explicit electronic commands, e.g., commands generated and sent to the robot by a smartphone application. The representations generated by the sensor subsystems may be referred to as “sensor inputs.”

The robot 100 also includes computing subsystems having data processing hardware, computer-readable media, and networking hardware. Each of these components can serve to provide the functionality of a portion or all of the input and output subsystems described above or as additional input and output subsystems of the robot 100, as the situation or application requires. For example, one or more integrated data processing apparatus can execute computer program instructions stored on computer-readable media in order to provide some of the functionality described above.

The robot 100 can also be configured to communicate with a cloud-based computing system having one or more computers in one or more locations. The cloud-based computing system can provide online support services for the robot. For example, the robot can offload portions of some of the operations described in this specification to the cloud-based system, e.g., for determining behaviors, computing signals, and performing natural language processing of audio streams.

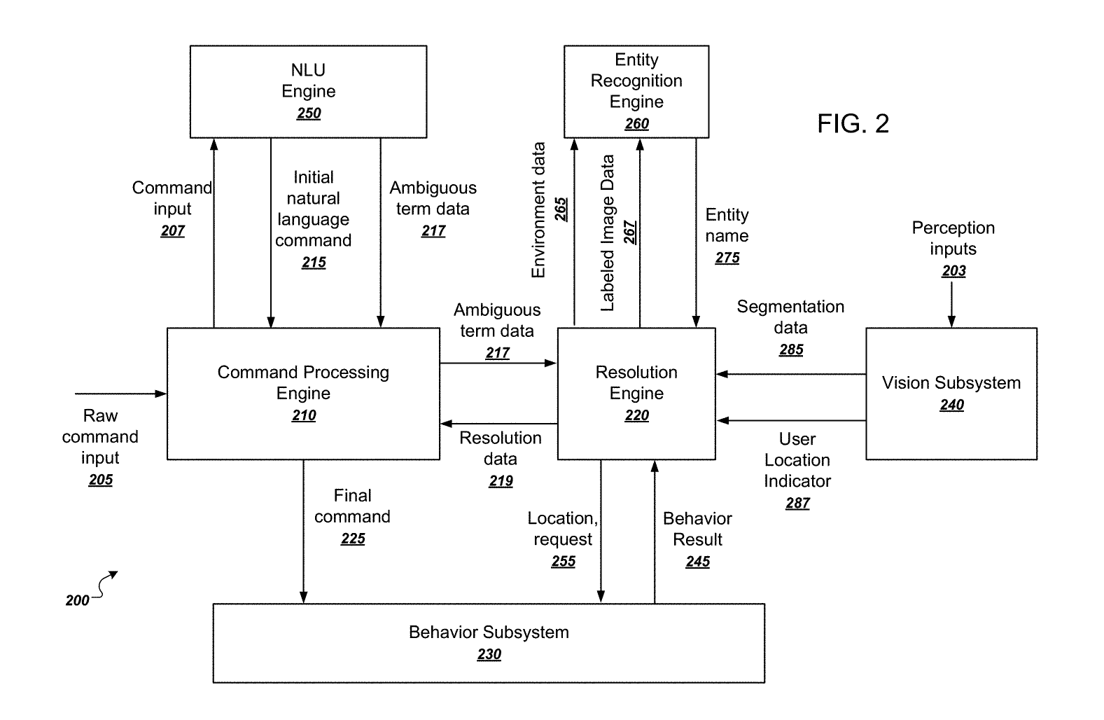

FIG. 2 illustrates the architecture of an example term resolution subsystem 200 of a robot. The term resolution subsystem 200 includes a resolution engine 220 that coordinates with a behavior subsystem 230 in order to select or generate behaviors that can be used to disambiguate ambiguous terms in natural language commands. The term resolution data that resolves the ambiguity of the term can then be used for a variety of applications.

The subsystem 200 includes a command processing engine 210, a resolution engine 220, a behavior subsystem 230, a vision subsystem 240, an NLU engine 250, and an entity recognition engine 260. Each of the components of FIG. 2 can be implemented in software, firmware, hardware, or some combination of these by computing components installed locally on a robot or in a remote computing system in communication with the robot. For example, some of the functionality of the components in FIG. 2 can be provided by one or more computer programs installed remotely on a cloud-based computing system or installed on a user device in communication with the robot. In some implementations, some functionalities of one or more of the vision subsystem 240, the NLU engine 250, and the entity recognition engine 260 are cloud-based, and the remaining functionalities are implemented by other components installed locally on the robot.

In operation, the command processing engine 210 can receive a raw command input 205 provided by a user. The user providing the user input is typically a person, although the user can also be non-human. For example, the user can be an animal, e.g., a pet; another robot; or a computer-controlled system that can produce audio, to name just a few examples. For example, the raw command input 205 can be a stream of audio contemporaneously captured by the robot or a user device associated with the robot. Alternatively or in addition, the raw command input 205 can be text received by the robot, e.g., as input provided by a user through an associated user device.

When the raw command input is audio input, the robot can use one or more installed functional components to determine when captured audio input is likely to correspond to a command. For example, suitable techniques for determining when a user is paying attention to a robot, and thus likely to be issuing voice commands, are described in commonly-owned U.S. patent application Ser. No. 15/694,710, titled “Robot Attention Detection,” which is herein incorporated by reference.

The command processing engine 210 can provide a command input 207 to the NLU engine 250 to perform natural language understanding for the raw command input 205. The command processing engine 210, the NLU engine 250, or both, can first perform speech recognition to transform the raw command input 205 into text. If the command processing engine 210 performs the speech recognition, the command input 207 can be text. Alternatively, if the NLU engine 250 performs the speech recognition, the command input 207 can be the same or a transformed, e.g., compressed, version of the raw command input 205. If the raw command input 205 was already text, the command input 207 can also be text.

The NLU engine 250 receives the command input 207 and performs natural language understanding processes on the command input to generate an initial natural language command 215. The initial natural language command 215 is a representation of a command for the robot to process. Thus, the initial natural language command 215 can simply be text or another representation of a command.

If the command input 207 included an ambiguous term, the NLU engine 250 can also provide ambiguous term data 217 back to the command processing engine 210. The ambiguous term data 217 indicates which terms recognized in the command input 207 are ambiguous terms whose meaning cannot be determined from the command itself. Thus, the ambiguous term data 217 can identify one or more ambiguous terms and, optionally, other metadata for one or more of the ambiguous terms.

The metadata of an ambiguous term can identify a type of the ambiguity. In some implementations, the NLU engine 250 classifies each ambiguous term as being an entity ambiguity term or a location ambiguity term.

An entity ambiguity is one or more terms in a command that reference a physical entity in the robot's environment that cannot be identified from the command itself. Common entity ambiguity terms include, “this,” “that,” “she,” “he,” “her,” “him,” and “it,” to name just a few examples. For example, the user command “pick that up” references something in the robot's environment that the robot should pick up. However, the name of the object or any other identifying information cannot be determined from the command itself because the object is referenced only by the ambiguous term “that.” Entity ambiguity terms can also include names of entities in the robot's environment. For example, the following names can be identified as entity ambiguity terms, “Jane,” “my room,” “the kitchen,” and “the dog,” to name just a few examples. For example, the user command “Say hello to Jane” includes a term that is the name of an entity, a user named Jane. However, the robot may not be able to determine which entity or person in the robot's environment is named “Jane” just from the term “Jane” in isolation.

A location ambiguity is one or more terms in a command that identify a location that cannot be determined from the command itself. Common location ambiguity terms include, “here,” “there,” and “over there,” to name just a few examples. For example, the user command “go over there” references a location in the robot's environment to which the robot should navigate. However, the location to which the robot should navigate cannot be determined from the command itself because the location is referenced only by the ambiguous term “there.”

Location ambiguities can also include location ambiguity phrases that identify a location in the environment with reference to one or more physical entities. Common location ambiguity phrases include, “by the <x>,” “next to the <x>,” and “to the <x>,” “to <x>,” where “<x>” is a placeholder for a name of a physical entity in the environment. For example, the user command “go over by that cube” references a location in the robot's environment to which the robot should navigate, or the command “sit next to him” references a person to which the robot should navigate. However, the location to which the robot should navigate cannot be determined from the command itself because the location is referenced only by the ambiguous phrase “by that cube.”

The classification as a location ambiguity or an entity ambiguity need not be mutually exclusive. For example, the term “that wall” can refer to the physical entity, to a location, or both. In some implementations, certain terms can be treated as a location ambiguity or an entity ambiguity depending on the context of the command. The term “that wall” could for example be disambiguated as a location entity for certain types of commands, e.g., navigation commands like, “go to that wall,” and could be disambiguated as an entity ambiguity for other types of commands, e.g., “What color is that wall?”, which is a command that seeks information about the wall as an entity rather than a command that relates to navigation.

The command processing engine 210 receives the initial natural language command 215 and possibly ambiguous term data 217 from the NLU engine 250. If no ambiguous term data 217 was received, the command processing engine 210 can use the initial natural language command 215 to generate a final command 225. The final command 225 represents an action to be taken by the robot. The final command 225 may, but need not, have a physical or visibly recognizable output. As will be described in more detail below, some commands cause the robot to internally assign a name to a physical entity but do not cause the robot to move.

The command processing engine can provide the final command 225 to the behavior subsystem 230 to select or generate an appropriate behavior. The final command 225 may, but need not, also be expressed in natural language form. Alternatively, the final command 225 can identify one or more of an enumerated set of behaviors. For example, the term “go” can be directly mapped to a command that directs the robot to drive, which is a command that can be parameterized by a particular location. The location parameter can be expressed using coordinates in an appropriate coordinate system, e.g., latitude and longitude, or a coordinate system in which the robot or another location in the environment is used as the origin.

In this specification, a “behavior” refers to one or more coordinated actions and optionally one or more responses that affect one or more output subsystems of the robot. The behavior subsystem 230 can thus determine a behavior and provide the behavior to the robot output subsystems for execution.

If, however, the command processing engine 210 receives ambiguous term data 217, the command processing engine 210 can provide the ambiguous term data 217 to a resolution engine 220. The resolution engine can work with the behavior subsystem 230 to perform one or more behaviors in order to attempt to resolve ambiguous terms identified by the ambiguous term data 217.

As part of the resolution processing, the resolution engine 220 can provide a location and a request 255 to the behavior subsystem 230. In response, the behavior subsystem 230 can generate a behavior that results in the robot turning toward or driving toward the provided location.

There are generally two objectives for the resolution engine 220 providing a location to the behavior subsystem 230. First, the resolution engine 220 can provide a location and a request 255 that direct the behavior subsystem 230 to search for an entity in the environment. Second, the resolution engine 220 can provide a location and a request 255 that direct the behavior subsystem 230 to search for a user location indicator.

In this specification, a user location indicator is an indication of a location that is provided by a user. The user location indicator can be captured by any appropriate combination of one or more sensor inputs. In many cases, the user location indicator is a visual indicator or an audio indicator. For example, a user can provide a visual user location indicator by gesturing at or toward a particular location. The gestures can take a variety of forms, e.g., finger pointing, head nods, hand motions, arm motions, moving or walking in a particular direction, or tapping a surface, to name just a few examples. A user can provide an audio location indicator by tapping on a surface, e.g., tapping on a table, or making noise with other objects. In some implementations, the user can provide gestures through the use of an auxiliary device or object, which can be either a device specially programmed to communicate with the robot, e.g., an accessory of the accessory subsystems described above, which may include using one or more integrated sensors of the accessory, e.g., touch sensors or gyrometers. Gestures can also be provided by a general-purpose pointing device, e.g., a laser pointer or a stick. As another example, a user can simply look toward a location and the robot can determine the location by performing gaze analysis.

As shown in FIG. 2, a vision subsystem 240 can generate user location indicators 287 computed from perception system inputs 203. The vision subsystem 240 can include one or more local perception subsystems described above with reference to FIG. 1. Alternatively or in addition, the vision subsystem can include sensor subsystems on companion devices, e.g., smartphones, as well as processing modules located on companion devices or in the cloud.

Searching for either a user location indicator or an entity based on the location can require turning toward the location, driving toward the location, or both. In some cases, driving toward the location requires the behavior subsystem 230 to plan a navigation path so that the robot can navigate in the environment around one or more other objects.

The behavior subsystem 230 can use the location and the request 255 to generate an appropriate searching behavior and provide the generated searching behavior for execution by one or more robot output subsystems. The robot output subsystems can then generate a behavior result 245, which represents an outcome of the corresponding behavior. For example, the behavior result 245 can indicate a new orientation of the robot, a location to which the robot traveled, a distance that the robot traveled, or one or more error conditions indicating that the proposed searching behavior was unsuccessful.

If the behavior result 245 was sufficient for the resolution engine 220 to resolve the ambiguous terms in the ambiguous term data, the resolution engine 220 can provide resolution data 219 to the command processing engine. For example, if the resolution engine 220 determined that “there” corresponded to a particular location on a surface, the resolution engine 220 can provide resolution data 219 that associates the term “there” with the determined location.

The command processing engine 210 can then use the resolution data 219 to generate a final command 225. For example, the command processing engine 210 can replace any ambiguous terms in the initial natural language command 215 using the resolution data 219.

The command processing engine 210 or another module can then execute the final command 225 itself or, if the final command requires a behavior, provide the final command 225 to the behavior subsystem 230 for selection of an appropriate behavior.

In some cases, the resolution engine 220 uses an entity recognition engine 260 to determine a name for an entity in the robot's environment. For example, if the resolution engine 220 directed the behavior subsystem 230 to generate a searching behavior to search for an entity, the robot may have turned toward a particular entity in the environment, e.g., a manipulable cube.

After the entity is in view, the robot can provide environment data 265 to the entity recognition engine 260. The environment data 265 can include information computed from one or more sensor subsystems, e.g., image data, distance data, or audio data.

The entity recognition engine 260 can then generate an entity identifier 275 and provide the entity identifier 275 back to the resolution engine 220. The entity identifier 275 can be a name of the entity or a key for the entity in a relation or database table. For example, the entity recognition engine can use one or more computer vision techniques to generate a name for an entity. If the entity is an object, the entity recognition engine 260 can use a trained classifier that generates an object class name for the object. If the entity is a user, the entity recognition engine can use information specifically maintained by the robot in order to determine a name or an identifier of the user, e.g., using previous introductions or interactions of the user with the robot.

In some implementations, the term resolution subsystem 200 can use the resolution data 219 to improve computer vision classification by the entity recognition engine 260. To do so, the resolution engine can provide labeled image data 267 for use by the entity recognition engine 260 in training one or more classifiers. The labeled image data 267 can also include segmentation data 285 computed by the vision subsystem 240. The segmentation data 285 can segment an image into one or more segments, with each segment having one or more objects to be recognized. The resolution engine 220 can include such segmentation data 285 when provided the labeled image data 267 to the entity recognition engine 260.

The entity recognition engine 260 can use the labeled image data 267 provided by the resolution engine 220 to update or train a new classification model. The trained model can either be a robot-specific model or a shared model. A robot-specific model is trained for use only by the robot that provided training images. The robot-specific models can help the entity recognition engine 260 to recognize objects in the environment of a single robot, e.g., a user's home, but would not extend to recognizing objects in the environments of other robots. A shared model, on the other hand, can be trained for use by all robots in a population of robots that use the entity recognition engine 260. The population of robots can be selected according to a particular attribute, e.g., one or more robots associated with a particular user account, robots in a particular country, robots in homes with children, or all robots. For example, all robots that provide labeled image data 267 can benefit from improved classification of the image data 267 provided by the robots as a whole.

The resolution engine 220 can then use the entity identifier 275 to generate resolution data 219. For example, the resolution data can specify that in the command “pick that up”, the term “that” refers to a cube at a particular location in the robot's environment. The command processing engine 210 can then use such information to generate a final command 225 that directs the behavior subsystem 230 to generate a behavior corresponding to the raw command input 205. For example, the final command 225 can instruct the behavior subsystem 230 to generate a behavior that involves driving toward the location of the cube and picking up the cube.

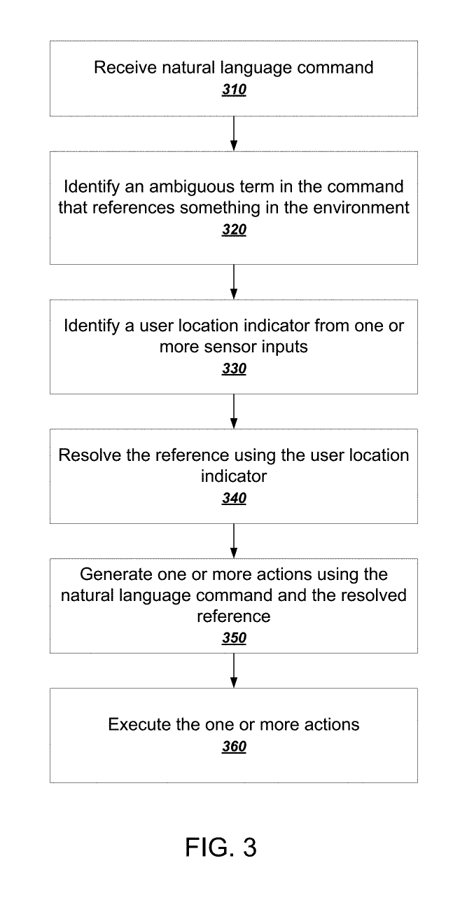

FIG. 3 is a flowchart of an example process for a robot to generate a modified command that resolves an ambiguous term in a command. The example process will be described as being performed by a robot programmed appropriately in accordance with this specification. For example, the robot 100 of FIG. 1, appropriately programmed, can perform the example process.

The robot receives a natural language command (310). As described above, the robot can receive the command through a captured stream of audio or as plain text input.

The robot identifies an ambiguous term in the command that references something in the environment (320). As described above, the ambiguous term can reference either a location in the environment or a physical entity in the environment.

The robot identifies a user location indicator from one or more sensor inputs (330). The robot can identify a user location indicator using one or more sensor inputs described above. For example, the robot can identify the user location indicator from an image of a user in the current field of view of the robot, from the sound a user is making captured by a microphone of the robot. Alternatively or in addition, the robot can perform a search within the environment in order to find a user location indicator. As described above, the user location indicator can be, for example, an arm gesture, a hand or finger gesture, or a gaze, to name just a few examples.

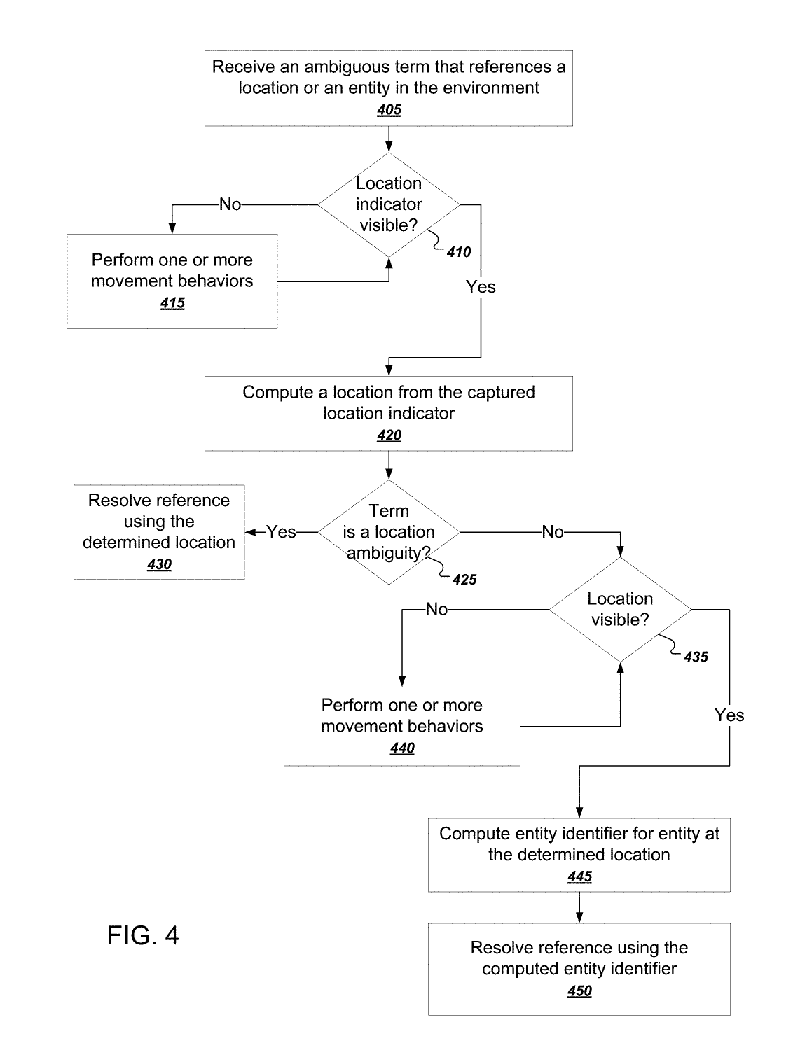

The robot resolves the reference using a user location indicator (340). The robot can then use a location computed from the user location indicator to generate resolution data that identifies a location, a name or a key of an entity, or both in the robot's environment. Resolving the reference of an ambiguous term using a user location indicator is described in more detail below with reference to FIG. 4.

The robot generates one or more actions using the natural language command and the resolved reference (350) and executes the one or more actions (360). For example, the robot can generate a modified command that replaces the ambiguous term with the resolution data or simply adds the resolution data to the original command and then executes the modified command.

For example, if the ambiguous term referenced a location, the robot can generate a command that directs the robot to navigate to the location. If the ambiguous term was the name of an entity in the environment, the robot can use the resolution data to generate an action that assigns the name to the entity.

As described above, the action may but need not result in the robot performing a physical action. For example, a first user can gesture toward a second user and say, “This is Lee.” The robot can recognize that “this” is an entity ambiguity and can use the first user's gesture to resolve the entity ambiguity as referring specifically to the second user. The robot can then perform an assignment action to assign a label having the name “Lee” to the second user. In some implementations, the robot can use computer vision capabilities, e.g., facial recognition or other features, to assign the label having the name “Lee” to a representation of the second user's features. Then, if the robot sees the second user in another location at another time, the robot can obtain the label in order to still recognize the name “Lee” as applying to the second user. Then, in a subsequent command, the robot can use the label to process the subsequent command. For example, if the first user then says, “Go to Lee,” the robot can recognize “to Lee” as being a location ambiguity that can be resolved by determining a location of a user matching the facial features of Lee.

As another example, the robot can assign a name to a physical entity in the environment of the robot. To do so, the robot can maintain a mapping between names and physical entities in the environment and optionally their respective locations. The robot can then use the mapping to process subsequent user commands.

For example, a user can gesture upwards and say, “This is my room.” The robot can determine that “this” is an entity ambiguity for an entity that cannot be resolved from the text of the command itself. The robot can thus use the user's gesture to identify that “this” refers to the physical space that the robot is currently in. The robot can then assign a name, “my room” to the physical space in an internal representation of the robot's environment. If a subsequent command references the assigned name, the robot can use the name to process the command. For example, user can then say, “Go to my room.” The robot can determine that the term “my room” is a name ambiguity that cannot be resolved from the text of the command itself. However, the robot can then determine that the name “my room” is assigned to a label for a physical location. The robot can then generate a modified command that causes the robot to navigate to the physical location corresponding to “my room.”

The robot can also maintain user-specific name assignments. This can accommodate the fact that multiple members of a household can mean entirely different things by the same name “my room.” In some implementations, the robot can use facial recognition or voice recognition to first determine an identity of the user issuing the command. This process can be triggered by the use of person-specific ambiguous terms, e.g., personal pronounces such as “my.” The robot can then obtain a user-specific name assignment for the user issuing the command. In this way, the robot can perform different actions for each of multiple users even if they issue the same commands.

These kinds of orientation commands can allow a user to easily orient the robot in a particular environment. For example, when the user first brings the robot home, the user can give the robot a home tour by simply speaking and gesturing toward specific rooms, e.g., “This is the kitchen.” The user can then easily direct the robot around the home by referring to the labels previously assigned to the rooms.

The robot can use these techniques to process multiple ambiguities in a same command. For example, the following command, “Go wait by that door for the kids to come home,” contains both a location ambiguity, e.g., “by that door,” as well as a name ambiguity, “the kids.” In this example, the robot will have previously learned how to recognize the children in the home, and thus can resolve the previously assigned name “the kids” to the previously recognized attributes, e.g., facial recognition attributes. The robot can use user location indicators to disambiguate “by that door” to mean a particular door in the house. After performing this action once, the robot can remember what location was previously associated with the action and the named user or users. For example, on a subsequent iteration, a user can issue the command, “Go wait for the kids to come home,” and the robot can determine that this command implicitly refers to the location of the door.

FIG. 4 is a flowchart of an example process for a robot to resolve an ambiguous term in a command. The example process will be described as being performed by a robot programmed appropriately in accordance with this specification. For example, the robot 100 of FIG. 1, appropriately programmed, can perform the example process.

The robot receives an ambiguous term that references a location or an entity in the environment (405).

The robot determines whether a location indicator is currently visible (410). The robot can use the current field of view of an integrated camera to determine if any users or users issuing commands are detected in the current field. For example, the robot can determine if any audio is detected from the direction of visible users or if mouth movement is detected by any visible users.

If any such users are visible, the robot can determine if any location indicators are visible. The robot can maintain a hierarchy of location indicators if multiple location indicators are visible. This is because users are nearly always looking at something, but that does not mean that they intend their gaze to be a location indicator. Therefore, in general the robot can consider larger movements to have higher priority in the hierarchy and smaller movements to have lesser priority in the hierarchy.

As one example, the robot can first determine if any arm gestures are detected. Arm gestures can include gesturing of one or both arms in a particular direction or gesturing toward a particular space, e.g., a room in general. For example, a user can hold up both hands to gesture toward the room the user is current standing in.

The robot can also determine if any hand or finger gestures, e.g., pointing or waving, are detected. For example, a user can wave a hand, tap on a surface, or point toward an object, to name just a few examples.

The robot can also then determine whether a detection of the user gaze toward a particular location is maintained for at least a threshold period of time.

If a location indicator is not visible (410), the robot can perform one or more movement actions (branch to 415). The robot can select the one or more movement behaviors so that one or more location indicators enter the field of view of the robot's integrated camera. Thus, for example, if a user is giving an audio command, the robot can determine a direction from which the sound came and then generate a movement action that causes the robot to turn toward or drive toward the direction of the sound. If a tapping noise is heard, the robot can also determine a direction from which the tapping sound came and then generate a movement action that causes the robot to turn toward the direction of the tapping sound.

As shown in FIG. 4, the determination of location indicator visibility and the one or more movement behaviors can be performed iteratively, e.g., until a location indicator becomes visible. For example, after the robot turns toward the direction of a sound (the first movement behavior), an obstacle may still obstruct the view of the user. Therefore, if the location indicator is still not visible (410), the robot can generate a second movement behavior that plans a navigation path around the obstacle. After performing the second movement behavior, the robot can once again determine whether a location indicator is visible.

When a location indicator becomes visible (410), the robot computes a location from the captured location indicator (branch to 420). This process generally involves determining a two-dimensional or three-dimensional vector from the captured location indicator and extending the vector in space until it intersects a predetermined end point.

The robot can use a variety of techniques for generating the vector. For example, for an arm movement, the robot can determine a general or average direction of travel of the arm. For finger pointing, the robot can determine a vector defined by the finger of the user. For gaze tracking, the robot can generate the vector based on a direction in which the user is looking.

The robot can then extend the vector to a particular end point. If the vector intersects with the surface of the robot's environment, the robot can use the intersection point as the determined location. If the vector does not intersect the surface of the robot's environment, the robot can use an intersection with a first object in the direction of the vector as the location or the location at which the vector reaches a maximum length.

The computed location can be defined as a single point in space or as a region. For example, the robot can compute a distribution of possible locations from the user location indicator, which can be represented as heat map of possible locations. As another example, the robot can project a cone or frustum along the direction of the computed vector, which defines an elliptical region where the environment surface is intersected.

The robot determines whether the term is a location ambiguity (425). As described above, terms that introduce location ambiguities include “here” and “there,” as well as terms in location ambiguity phrases, e.g., “by the cube.”

If the term is a location ambiguity, the robot resolves the reference using the determined location (branch to 430). In other words, the robot associates the original ambiguous term with the determined location so that the robot can generate a disambiguated command.

If the term is not a location ambiguity, the robot can perform additional actions in order to disambiguate the term using the determined location.

If the term is not a location ambiguity (425), the robot determines whether the determined location is visible (branch to 435). In other words, the robot determines whether the location determined from the user location indicator is currently within the robot's field of view.

If not, the robot performs one or more movement behaviors (branch to 440), and again determines if the location is visible (425). Similar to searching for a location indicator, searching for the determined location can also be an iterative process in which the robot generates a sequence of behaviors to turn toward the determined location and possibly navigate around obstacles that block the location from the robot's field of view.

In some implementations, even if the location is visible, the robot may still need more information. As another example, if the size of the entity is unclear, the robot can ask for a clarification. For example, “over there” might refer to a region in the environment generally or to single point in space in particular. When this is not clear, the robot can ask the user for a clarification.

For example, if there are multiple objects near the location, the robot can still perform one or more movement behaviors to get a better view of which of the objects is closest to the determined location. Alternatively or in addition, the robot can prompt the user for more information. For example, if the robot can determine entity names for each of multiple objects, the robot can ask the user to specifically indicate which object is being referred to, e.g., by asking “Do you mean the cup or the cube?” or simply “Which one?”

The prompt for more information need not be an explicit question posed to the user. For example, the robot can simply start navigating toward one of the multiple objects and wait for a user correction. If no additional user commands are issued, the robot has selected the correct object.

If another user command is issued, the robot can change course to navigate toward the correct object. In some implementations, the robot can make use of corrections as negative training examples for computer vision training. For example, if the robot starts navigating toward an object the user has described as a “ball,” and the user issues a correction, the robot can provide an image of the object to the computer vision system with a label indicating that the object is not a ball.

When the location becomes visible (435), the robot computes an entity identifier for an entity at the determined location (branch to 445). As described above, the robot can use an entity recognition engine that uses machine-learned computer vision techniques to determine a name or a key of an object at the determined location. Alternatively or in addition, the robot can perform facial recognition to determine a name or a key of a known user at the determined location.

The robot resolves the reference using the computed entity identifier (450). In other words, the robot associates the original ambiguous term with the computed entity identifier so that the robot can generate a disambiguated command.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For a robot to be configured to perform particular operations or actions means that the system has installed on it software, firmware, hardware, or a combination of them that in operation cause the robot to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a robot, a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a robot comprising:
a body and one or more physically moveable components;
one or more processors; and
one or more storage devices storing instructions that are operable, when executed by the one or more processors, to cause the robot to perform operations comprising:
   receiving a natural language command from a user;
   identifying an ambiguous term in the command, wherein the ambiguous term references a location or an entity in an environment of the robot;
   identifying a user location indicator from one or more sensor inputs;
   computing a location within the environment of the robot using the location indicator identified from the one or more sensor inputs;
   computing resolution data using the computed location, wherein the resolution data resolves the reference of the ambiguous term;
   generating one or more actions using the natural language command and the resolved reference of the ambiguous term; and
   executing the one or more actions.

Embodiment 2 is the robot of embodiment 1, wherein the one or more actions comprise assigning a label to an entity in the environment of the robot based on the computed resolution data.

Embodiment 3 is the robot of embodiment 2, wherein assigning a label to an entity in the environment comprises assigning a name of a room to a physical location within the environment.

Embodiment 4 is the robot of embodiment 3, wherein the operations further comprise:
receiving a second natural language command that references the room name; and
performing a behavior relating to the particular room in response to receiving the second natural language command.

Embodiment 5 is the robot of embodiment 4, wherein performing the behavior relating to the particular room comprises navigating to the particular room.

Embodiment 6 is the robot of embodiment 2, wherein the name assigned to the physical entity is a name of a user in the environment.

Embodiment 7 is the robot of embodiment 2, wherein the operations further comprise:
receiving a second natural language command from a user, the second natural language command having an ambiguous term;
determining that the ambiguous term is the name of a label assigned to an entity in the robot's environment; and
generating a modified command that replaces the ambiguous term with the name of the label assigned to the entity in the robot's environment.

Embodiment 8 is the robot of any one of embodiments 1-7, wherein the operations further comprise:
determining that the ambiguous term includes a possessive pronoun;
identifying a user who issued the command; and
associating the entity with the identified user who issued the command.

Embodiment 9 is the robot of embodiment 2, wherein the operations further comprise:
obtaining an image of the robot's environment containing the physical entity;
labeling the image with the name assigned to the physical entity; and
providing the labeled image as a training example to a computer vision system.

Embodiment 10 is the robot of embodiment 9, wherein the operations further comprise:
training, by the computer vision system, a model using the image labeled with the name assigned to the physical entity in the environment of the robot.

Embodiment 11 is the robot of embodiment 10, wherein the model is a robot-specific model for use by only the robot or the model is shared model for use by one or more other robots.

Embodiment 12 is the robot of embodiments 1-11, wherein identifying a user location indicator captured from an image of the user comprises:
determining that a user location indicator is not within a field of view of an integrated camera of the robot; and
in response, performing one or more movement behaviors until a user location indicator is within the field of view of the integrated camera.

Embodiment 13 is the robot of embodiment 12, wherein performing the one or more movement behaviors comprises:
determining a direction from which a stream of captured audio originated; and
turning toward the direction, driving toward the direction, or both.

Embodiment 14 is the robot of embodiment 13, wherein the operations further comprise:
determining that an obstacle blocks a view of a user; and
in response, performing one or more movement behaviors to navigate around the obstacle.

Embodiment 15 is the robot of any one of embodiments 1-14, wherein computing a location within the environment of the robot using the location indicator captured from the image of the user comprises:
identifying a gesture or a gaze by the user toward a particular location in the environment of the robot;
generating a vector based on the gesture made by the user; and
computing a location as an intersection point of the vector when extended.

Embodiment 16 is the robot of embodiment 15, wherein the intersection point is a point on a surface of the environment.

Embodiment 17 is the robot of embodiment 15, wherein the gesture made by the user comprises moving an arm or pointing a finger.

Embodiment 18 is the robot of embodiment 15, wherein identifying a gesture or a gaze by the user toward a particular location in the environment of the robot comprises evaluating criteria in the following order:
determining whether a large gesture is detected;
determining whether a small gesture is detected; and
determining whether a gaze is detected.

Embodiment 19 is the robot of any one of embodiments 1-18, wherein computing resolution data using the computed location comprises:
determining that the computed location is not within a field of view of an integrated camera;
in response, performing one or more movement behaviors until the computed location is within the field of view of the integrated camera.

Embodiment 20 is the robot of any one of embodiments 1-19, wherein computing resolution data using the computed location comprises computing a name of a physical entity at the computed location in the environment of the robot.

Embodiment 21 is the robot of any one of embodiments 1-20, wherein computing the resolution data using the computed location comprises:
determining that the ambiguous term is a location ambiguity; and
in response, generating a navigation action based on the computed location.

Embodiment 22 is the robot of any one of embodiments 1-21, wherein computing the resolution data using the computed location comprises:
determining that the ambiguous term is an entity ambiguity;
in response, determining a name of an entity at the computed location; and
generating an action based on the name of the entity at the computed location.

Embodiment 23 is a method comprising the operations performed by the robot of any one of embodiments 1-22.

Embodiment 24 is a computer storage medium encoded with a computer program, the program comprising instructions that are operable, when executed by data processing apparatus, to cause the data processing apparatus to perform the operations of any one of embodiments 1-22.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A robot comprising:
a body and one or more physically moveable components;
one or more processors; and
one or more storage devices storing instructions that are operable, when executed by the one or more processors, to cause the robot to perform operations comprising:
receiving a natural language command from a user;
identifying an ambiguous term in the command, wherein the ambiguous term references a location or an entity in an environment of the robot;
identifying a user location indicator from one or more sensor inputs;
computing a location within the environment of the robot using the location indicator identified from the one or more sensor inputs;
computing resolution data using the computed location, wherein the resolution data resolves the reference of the ambiguous term;
generating one or more actions using the natural language command and the resolved reference of the ambiguous term; and
executing the one or more actions.

2. The robot of claim 1, wherein the one or more actions comprise assigning a label to an entity in the environment of the robot based on the computed resolution data.

3. The robot of claim 2, wherein assigning a label to an entity in the environment comprises assigning a name of a room to a physical location within the environment.

4. The robot of claim 3, wherein the operations further comprise:
receiving a second natural language command that references the room name; and
performing a behavior relating to the particular room in response to receiving the second natural language command.

5. The robot of claim 4, wherein performing the behavior relating to the particular room comprises navigating to the particular room.

6. The robot of claim 2, wherein the name assigned to the physical entity is a name of a user in the environment.

7. The robot of claim 2, wherein the operations further comprise:
receiving a second natural language command from a user, the second natural language command having an ambiguous term;
determining that the ambiguous term is the name of a label assigned to an entity in the robot's environment; and
generating a modified command that replaces the ambiguous term with the name of the label assigned to the entity in the robot's environment.

8. The robot of claim 1, wherein the operations further comprise:
determining that the ambiguous term includes a possessive pronoun;
identifying a user who issued the command; and
associating the entity with the identified user who issued the command.

9. The robot of claim 2, wherein the operations further comprise:
obtaining an image of the robot's environment containing the physical entity;
labeling the image with the name assigned to the physical entity; and
providing the labeled image as a training example to a computer vision system.

10. The robot of claim 9, wherein the operations further comprise:
training, by the computer vision system, a model using the image labeled with the name assigned to the physical entity in the environment of the robot.

11. The robot of claim 10, wherein the model is a robot-specific model for use by only the robot or the model is shared model for use by one or more other robots.

12. The robot of claim 1, wherein identifying a user location indicator captured from an image of the user comprises:
determining that a user location indicator is not within a field of view of an integrated camera of the robot; and
in response, performing one or more movement behaviors until a user location indicator is within the field of view of the integrated camera.

13. The robot of claim 12, wherein performing the one or more movement behaviors comprises:
determining a direction from which a stream of captured audio originated; and
turning toward the direction, navigating toward the direction, or both.

14. The robot of claim 13, wherein the operations further comprise:
determining that an obstacle blocks a view of a user; and
in response, performing one or more movement behaviors to navigate around the obstacle.

15. The robot of claim 1, wherein computing a location within the environment of the robot using the location indicator captured from the image of the user comprises:
identifying a gesture or a gaze by the user toward a particular location in the environment of the robot;
generating a vector based on the gesture made by the user; and
computing a location as an intersection point of the vector when extended.

16. The robot of claim 15, wherein the intersection point is a point on a surface of the environment.

17. The robot of claim 15, wherein the gesture made by the user comprises moving an arm or pointing a finger.

18. The robot of claim 15, wherein identifying a gesture or a gaze by the user toward a particular location in the environment of the robot comprises evaluating criteria in the following order:
determining whether a large gesture is detected;
determining whether a small gesture is detected; and
determining whether a gaze is detected.

19. The robot of claim 1, wherein computing resolution data using the computed location comprises:
determining that the computed location is not within a field of view of an integrated camera;
in response, performing one or more movement behaviors until the computed location is within the field of view of the integrated camera.

20. The robot of claim 1, wherein computing resolution data using the computed location comprises computing a name of a physical entity at the computed location in the environment of the robot.

21. The robot of claim 1, wherein computing the resolution data using the computed location comprises:
determining that the ambiguous term is a location ambiguity; and
in response, generating a navigation action based on the computed location.

22. The robot of claim 1, wherein computing the resolution data using the computed location comprises:
determining that the ambiguous term is an entity ambiguity;
in response, determining a name of an entity at the computed location; and
generating an action based on the name of the entity at the computed location

23. An apparatus comprising:
one or more physically moveable components;
one or more processors; and
one or more storage devices storing instructions that are operable, when executed by the one or more processors, to cause the apparatus to perform operations comprising:
receiving a natural language command from a user;
identifying an ambiguous term in the command, wherein the ambiguous term references a location or an entity in an environment of the apparatus;
identifying a user location indicator from one or more sensor inputs;
computing a location within the environment of the apparatus using the location indicator identified from the one or more sensor inputs;
computing resolution data using the computed location, wherein the resolution data resolves the reference of the ambiguous term;
generating one or more actions using the natural language command and the resolved reference of the ambiguous term; and
executing the one or more actions.

24. One or more non-transitory computer storage media encoded with computer program instructions that when executed by a robot having one or more processors cause the robot to perform operations comprising:
receiving a natural language command from a user;
identifying an ambiguous term in the command, wherein the ambiguous term references a location or an entity in an environment of the robot;
identifying a user location indicator from one or more sensor inputs;
computing a location within the environment of the robot using the location indicator identified from the one or more sensor inputs;
computing resolution data using the computed location, wherein the resolution data resolves the reference of the ambiguous term;
generating one or more actions using the natural language command and the resolved reference of the ambiguous term; and
executing the one or more actions.
